(19) United States
(12) Patent Application Publication
(10) Pub. No.: US 2026/0203138 A1
(43) Pub. Date: Jul. 16, 2026

(54) DISTRIBUTED LCS CONFIGURATION SYSTEM

(71) Applicant: Dell Products L.P., Round Rock, TX (US)

(72) Inventors: Andi Zhou, Durham, NC (US); Sanne Bloemsma, Cedar Park, TX (US); Ethan A. Kaley, North Kingstown, RI (US); Sheldon Abrams, Apex, NC (US)

(21) Appl. No.: 19/019,739

(22) Filed: Jan. 14, 2025

(51) Int. Cl. G06F 9/50

(52) U.S. Cl. CPC G06F 9/5083

(57) ABSTRACT

A distributed LCS configuration system includes a BMS with a processing/memory system providing a microvisor including a microvisor agent, and a BMS SCP device including a BMS SCP agent. A resource SCP device is coupled to a resource device and includes a resource SCP agent. A resource management system coupled to the BMS and the resource SCP device includes a resource management agent. The resource management system composes an LCS based on a workload intent using the processing/memory system and the resource device, provides LCS resource configuration information to the resource SCP agent, and provides LCS configuration information to the BMS SCP agent. The BMS SCP agent then configures the first resource device with the first resource SCP agent using the LCS first resource configuration information, and configures the processing/memory system with a microvisor agent using the LCS configuration information to provide the LCS that operates with the resource device.

### BACKGROUND

The present disclosure relates generally to information handling systems, and more particularly to distributing the configuration of LCSs that are provided using information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

While conventional information handling systems such as, for example, server devices and/or other computing devices known in the art have traditionally been provided with particular information handling systems components that configure them to satisfy one or more use cases, new computing paradigms provide for the allocation of resources from information handling systems and/or information handling system components for use in Logically Composed Systems (LCSs) that may be composed as needed to satisfy any computing intent/workload, and then decomposed such that those resources may be utilized in other LCSs. As such, users of the LCSs may be provided with LCSs that meet their current needs for any particular workload they require.

For example, an LCS may be provided using a Bare Metal Server (BMS), with processing resources and memory resources in the BMS used to provide an Operating System (OS) for the LCS, and with different resources that may be included in the BMS and/or that are connected to the BMS via a network used to provide any desired functionality for the LCS. As such, LCSs may be composed of disaggregated, heterogeneous resources that may be used to perform operations for that LCS. The provisioning of LCSs requires the configuration of its resources to perform the functionality of the LCS, and conventional LCS configuration systems provide all of the configuration information for the LCS to a centralized, monolithic orchestrator device, with the centralized, monolithic orchestrator device then using that configuration information to configure the processing resources and memory resources in the BMS along with each of the different resources included in the BMS and/or connected to the BMS via the network to provide the LCS.

However, as the resources available to provide LCSs become more and more disaggregated, the configuration of resources to provide an LCS from such a centralized, monolithic orchestrator device raises issues. For example, the centralized, monolithic orchestrator device discussed above requires a centralized, monolithic Application Programming Interface (API) to configure and manage the resources as described above, each of which is provided with a corresponding API to interact with the centralized, monolithic orchestrator device. However, hardware and/or software utilized by resources scales faster than management and control systems like those provided by the centralized, monolithic orchestrator device, and thus the APIs provided for resources may be updated frequently, with each of those updates requiring a corresponding update in the centralized, monolithic API for the centralized, monolithic orchestrator device in order to ensure that the configuration of LCSs discussed above may be performed. Furthermore, the centralized, monolithic orchestrator device must be provided with all business logic for the LCS configuration system that is configured to handle each of the LCS provisioning variants that are available, and the APIs provided for resources must be configured such that they are compliant with API policy standards and API security standards when interacting with the centralized, monolithic orchestrator device (i.e., to ensure that they operate within their resource domain and do not compromise the security of the resource domains of other resources).

One conventional solution to such issues is the provisioning of a dedicated group of “configuration” resource devices that operate to configure LCSs. However, because such “configuration” resource devices are dedicated to the configuration of LCSs and cannot be used to perform workloads, they increase the expense, complexity, and inefficiency of the LCS provisioning system, a problem which is exacerbated as the LCS provisioning systems scale and requires the number of such “configuration” resource devices to scale as well.

Accordingly, it would be desirable to provide an LCS configuration system that addresses the issues discussed above.

### SUMMARY

According to one embodiment, a Bare Metal Server (BMS) includes a Bare Metal Server (BMS) System Control Processor (SCP) processing system; a BMS SCP memory system that is coupled to the BMS SCP processing system and that includes instructions that, when executed by the BMS SCP processing system, cause the BMS SCP processing system to provide a BMC SCP engine including a BMC SCP agent; a microvisor processing system; and a microvisor memory system that is coupled to the microvisor processing system and that includes instructions that, when executed by the microvisor processing system, cause the microvisor processing system to provide a microvisor engine including a microvisor agent, wherein the BMC SCP agent is configured to: receive, from a resource management agent in a resource management system, Logically Composed System (LCS) configuration information for configuring an LCS; configure, with a first resource SCP agent included in a first resource SCP device using LCS first resource configuration information provided on the first resource SCP device, a first resource device that is coupled to the first resource SCP; and configure, with microvisor agent using LCS configuration information provided on the microvisor engine, the microvisor processing system and the microvisor memory system to provide the LCS that operates with the first resource device.

### BRIEF DESCRIPTION OF THE DRAWINGS

FIG. 1 is a schematic view illustrating an embodiment of an Information Handling System (IHS).

FIG. 2 is a schematic view illustrating an embodiment of an LCS provisioning system.

FIG. 3 is a schematic view illustrating an embodiment of an LCS provisioning subsystem that may be included in the LCS provisioning system of FIG. 2.

FIG. 4 is a schematic view illustrating an embodiment of a resource system that may be included in the LCS provisioning subsystem of FIG. 3.

FIG. 5 is a schematic view illustrating an embodiment of the provisioning of an LCS using the LCS provisioning system of FIG. 2.

FIG. 6 is a schematic view illustrating an embodiment of the provisioning of an LCS using the LCS provisioning system of FIG. 2.

FIG. 7 is a flow chart illustrating an embodiment of a method for distributed configuration of an LCS.

FIG. 8 is a schematic view illustrating an embodiment of the LCS provisioning subsystem of FIG. 3.

FIG. 9A is a schematic view illustrating an embodiment of the LCS provisioning subsystem of FIG. 8 operating during the method of FIG. 7.

FIG. 9B is a schematic view illustrating an embodiment of the LCS provisioning subsystem of FIG. 8 operating during the method of FIG. 7.

FIG. 9C is a schematic view illustrating an embodiment of the LCS provisioning subsystem of FIG. 8 operating during the method of FIG. 7.

FIG. 10 is a schematic view illustrating an embodiment of the LCS provisioning subsystem of FIG. 8 operating during the method of FIG. 7.

FIG. 11A is a schematic view illustrating an embodiment of the LCS provisioning subsystem of FIG. 8 operating during the method of FIG. 7.

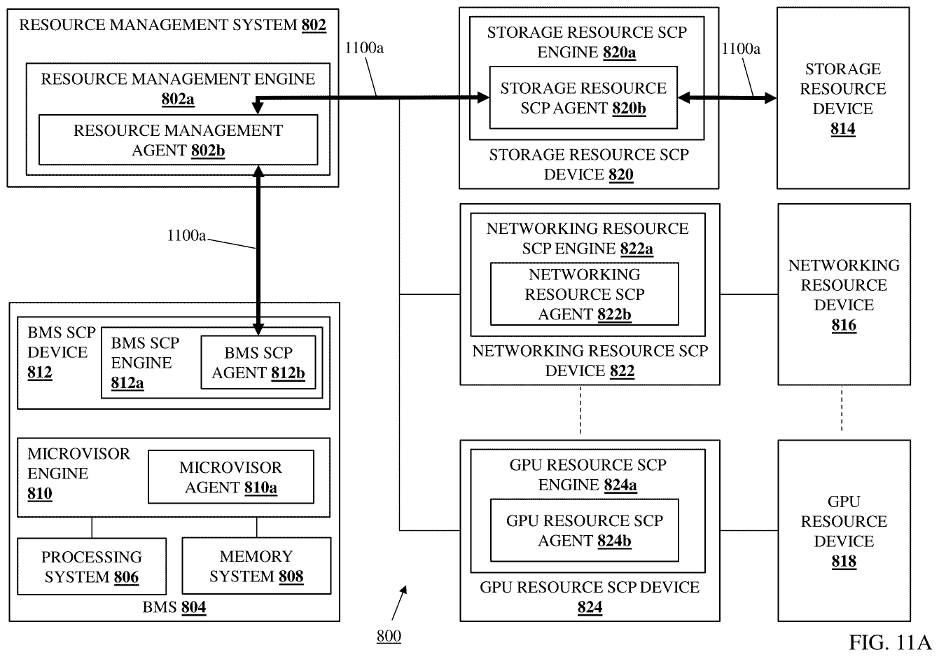

FIG. 11B is a schematic view illustrating an embodiment of the LCS provisioning subsystem of FIG. 8 operating during the method of FIG. 7.

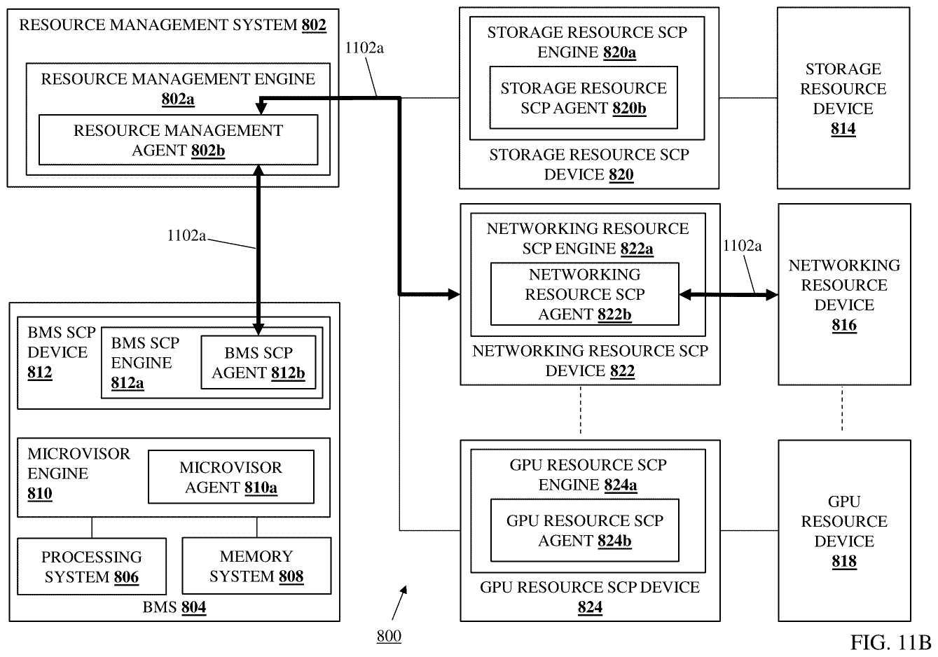

FIG. 11C is a schematic view illustrating an embodiment of the LCS provisioning subsystem of FIG. 8 operating during the method of FIG. 7.

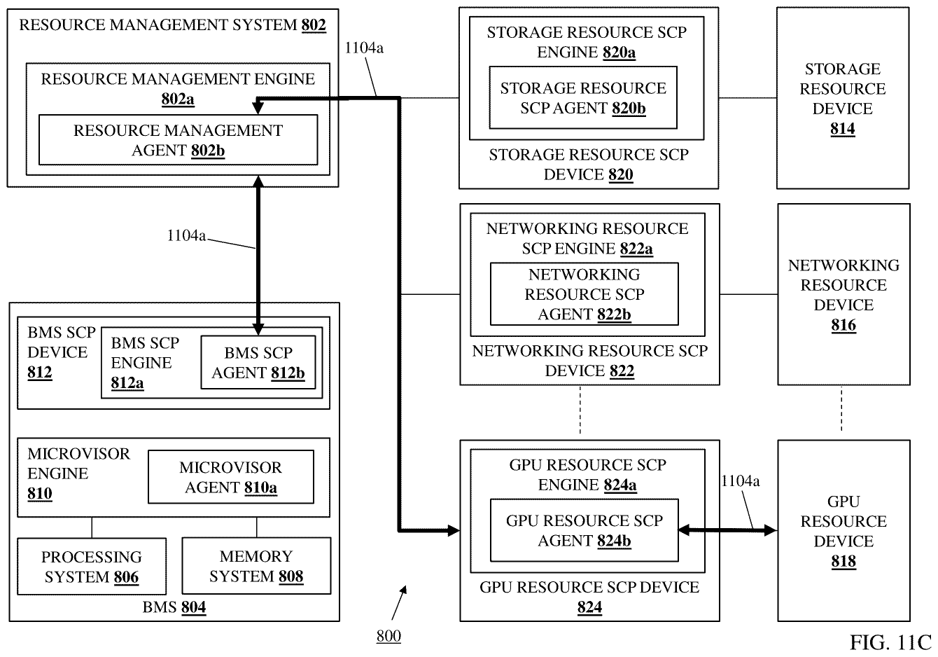

FIG. 12 is a schematic view illustrating an embodiment of the LCS provisioning subsystem of FIG. 8 operating during the method of FIG. 7.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

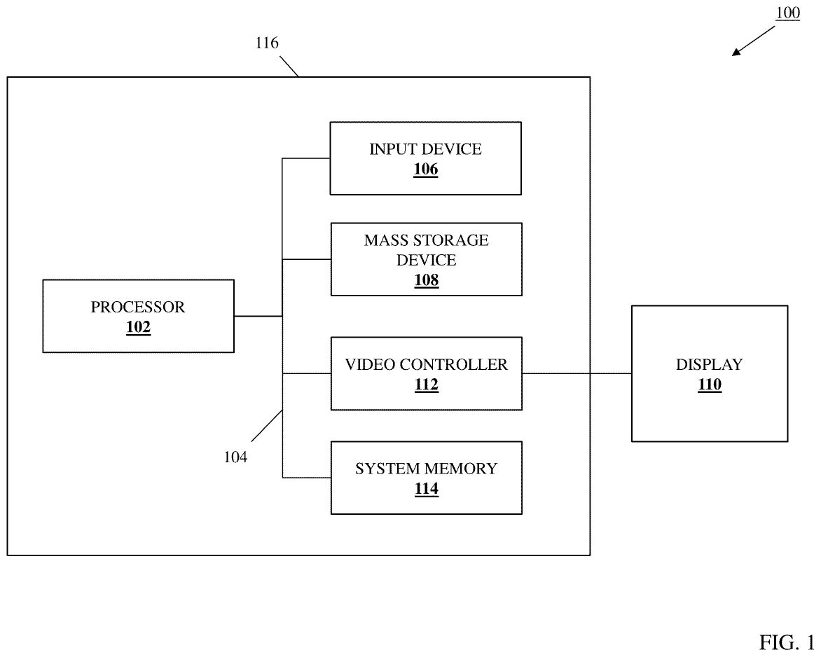

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

As discussed in further detail below, the distributed Logically Composed System (LCS) configuration systems and methods of the present disclosure may be utilized with LCSs, which one of skill in the art in possession of the present disclosure will recognize may be provided to users as part of an intent-based, as-a-Service delivery platform that enables multi-cloud computing while keeping the corresponding infrastructure that is utilized to do so “invisible” to the user in order to, for example, simplify the user/workload performance experience. As such, the LCSs discussed herein enable relatively rapid utilization of technology from a relatively broader resource pool, optimize the allocation of resources to workloads to provide improved scalability and efficiency, enable seamless introduction of new technologies and value-add services, and/or provide a variety of other benefits that would be apparent to one of skill in the art in possession of the present disclosure.

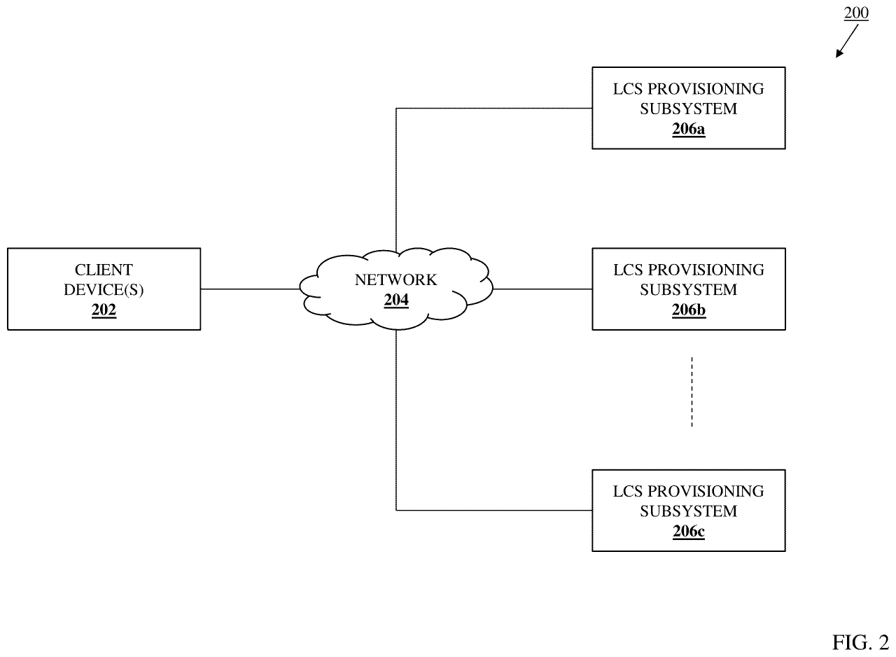

With reference to FIG. 2, an embodiment of a Logically Composed System (LCS) provisioning system 200 is illustrated that may be utilized with the distributed LCS configuration systems and methods of the present disclosure. In the illustrated embodiment, the LCS provisioning system 200 includes one or more client devices 202. In an embodiment, any or all of the client devices may be provided by the IHS 100 discussed above with reference to FIG. 1 and/or may include some or all of the components of the IHS 100, and in specific examples may be provided by desktop computing devices, laptop/notebook computing devices, tablet computing devices, mobile phones, and/or any other computing device known in the art. However, while illustrated and discussed as being provided by specific computing devices, one of skill in the art in possession of the present disclosure will recognize that the functionality of the client device(s) 202 discussed below may be provided by other computing devices that are configured to operate similarly as the client device(s) 202 discussed below, and that one of skill in the art in possession of the present disclosure would recognize as utilizing the LCSs described herein. As illustrated, the client device(s) 202 may be coupled to a network 204 that may be provided by a Local Area Network (LAN), the Internet, combinations thereof, and/or any of network that would be apparent to one of skill in the art in possession of the present disclosure.

As also illustrated in FIG. 2, a plurality of LCS provisioning subsystems 206a, 206b, and up to 206c are coupled to the network 204 such that any or all of those LCS provisioning subsystems 206a-206c may provide LCSs to the client device(s) 202 as discussed in further detail below. In an embodiment, any or all of the LCS provisioning subsystems 206a-206c may include one or more of the IHS 100 discussed above with reference to FIG. 1 and/or may include some or all of the components of the IHS 100. For example, in some of the specific examples provided below, each of the LCS provisioning subsystems 206a-206c may be provided by a respective datacenter or other computing device/computing component location (e.g., a respective one of the “clouds” that enables the “multi-cloud” computing discussed above) in which the components of that LCS provisioning subsystem are included. However, while a specific configuration of the LCS provisioning system 200 (e.g., including multiple LCS provisioning subsystems 206a-206c) is illustrated and described, one of skill in the art in possession of the present disclosure will recognize that other configurations of the LCS provisioning system 200 (e.g., a single LCS provisioning subsystem, LCS provisioning subsystems that span multiple datacenters/computing device/computing component locations, etc.) will fall within the scope of the present disclosure as well.

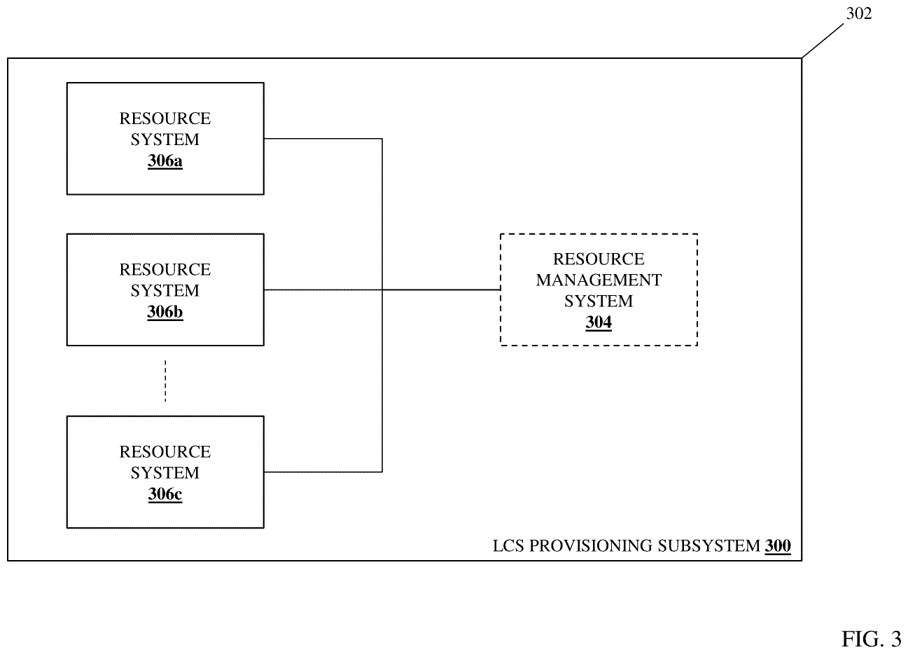

With reference to FIG. 3, an embodiment of an LCS provisioning subsystem 300 is illustrated that may provide any of the LCS provisioning subsystems 206a-206c discussed above with reference to FIG. 2. As such, the LCS provisioning subsystem 300 may include one or more of the IHS 100 discussed above with reference to FIG. 1 and/or may include some or all of the components of the IHS 100, and in the specific examples provided below may be provided by a datacenter or other computing device/computing component location in which the components of the LCS provisioning subsystem 300 are included. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

In the illustrated embodiment, the LCS provisioning subsystem 300 is provided in a datacenter 302, and includes a resource management system 304 coupled to a plurality of resource systems 306a, 306b, and up to 306c. In an embodiment, any of the resource management system 304 and the resource systems 306a-306c may be provided by the IHS 100 discussed above with reference to FIG. 1 and/or may include some or all of the components of the IHS 100. In the specific embodiments provided below, each of the resource management system 304 and the resource systems 306a-306c may include a System Control Processor (SCP) device that may be conceptualized as an “enhanced” SmartNIC device that may be configured to perform functionality that is not available in conventional SmartNIC devices such as, for example, the resource management functionality, LCS provisioning functionality, and/or other SCP functionality described herein.

In an embodiment, any of the resource systems 306a-306c may include any of the resources described below coupled to an SCP device that is configured to facilitate management of those resources by the resource management system 304. Furthermore, the SCP device included in the resource management system 304 may provide an SCP Manager (SCPM) subsystem that is configured to manage the SCP devices in the resource systems 306a-306c, and that performs the functionality of the resource management system 304 described below. In some examples, the resource management system 304 may be provided by a “stand-alone” system (e.g., that is provided in a separate chassis from each of the resource systems 306a-306c), and the SCPM subsystem discussed below may be provided by a dedicated SCP device, processing/memory resources, and/or other components in that resource management system 304. However, in other embodiments, the resource management system 304 may be provided by one of the resource systems 306a-306c (e.g., it may be provided in a chassis of one of the resource systems 306a-306c), and the SCPM subsystem may be provided by an SCP device, processing/memory resources, and/or any other components om that resource system.

As such, the resource management system 304 is illustrated with dashed lines in FIG. 3 to indicate that it may be a stand-alone system in some embodiments, or may be provided by one of the resource systems 306a-306c in other embodiments. Furthermore, one of skill in the art in possession of the present disclosure will appreciate how SCP devices in the resource systems 306a-306c may operate to “elect” or otherwise select one or more of those SCP devices to operate as the SCPM subsystem that provides the resource management system 304 described below. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

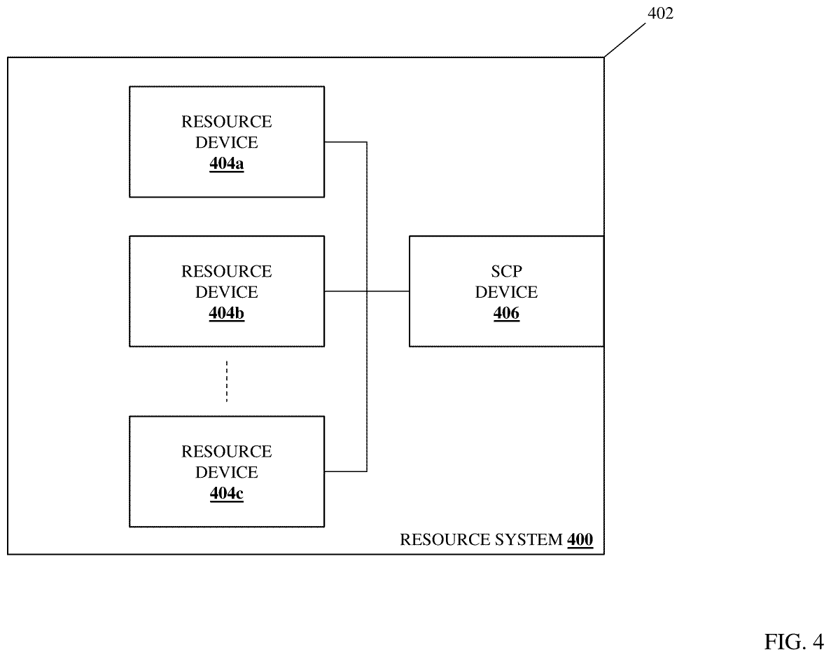

With reference to FIG. 4, an embodiment of a resource system 400 is illustrated that may provide any or all of the resource systems 306a-306c discussed above with reference to FIG. 3. In an embodiment, the resource system 400 may be provided by the IHS 100 discussed above with reference to FIG. 1 and/or may include some or all of the components of the IHS 100. In the illustrated embodiment, the resource system 400 includes a chassis 402 that houses the components of the resource system 400, only some of which are illustrated and discussed below. In the illustrated embodiment, the chassis 402 houses an SCP device 406. In an embodiment, the SCP device 406 may include a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide an SCP engine that is configured to perform the functionality of the SCP engines and/or SCP devices discussed below. Furthermore, the SCP device 406 may also include any of a variety of SCP components (e.g., hardware/software) that are configured to enable any of the SCP functionality described below.

In the illustrated embodiment, the chassis 402 also houses a plurality of resource devices 404a, 404b, and up to 404c, each of which is coupled to the SCP device 406. For example, the resource devices 404a-404c may include processing systems (e.g., first type processing systems such as those available from INTEL® Corporation of Santa Clara, California, United States, second type processing systems such as those available from ADVANCED MICRO DEVICES (AMD)® Inc. of Santa Clara, California, United States, Advanced Reduced Instruction Set Computer (RISC) Machine (ARM) devices, Graphics Processing Unit (GPU) devices, Tensor Processing Unit (TPU) devices, Field Programmable Gate Array (FPGA) devices, accelerator devices, etc.); memory systems (e.g., Persistence MEMory (PMEM) devices (e.g., solid state byte-addressable memory devices that reside on a memory bus), etc.); storage devices (e.g., Non-Volatile Memory express over Fabric (NVMe-oF) storage devices, Just a Bunch Of Flash (JBOF) devices, etc.); networking devices (e.g., Network Interface Controller (NIC) devices, etc.); and/or any other devices that one of skill in the art in possession of the present disclosure would recognize as enabling the functionality described as being enabled by the resource devices 404a-404c discussed below. As such, the resource devices 404a-404c in the resource systems 306a-306c/400 may be considered a “pool” of resources that are available to the resource management system 304 for use in composing LCSs.

To provide a specific example, the SCP devices described herein may operate to provide a Root-of-Trust (RoT) for their corresponding resource devices/systems, to provide an intent management engine for managing the workload intents discussed below, to perform telemetry generation and/or reporting operations for their corresponding resource devices/systems, to perform identity operations for their corresponding resource devices/systems, provide an image boot engine (e.g., an operating system image boot engine) for LCSs composed using a processing system/memory system controlled by that SCP device, and/or perform any other operations that one of skill in the art in possession of the present disclosure would recognize as providing the functionality described below. Further, as discussed below, the SCP devices describe herein may include Software-Defined Storage (SDS) subsystems, inference subsystems, data protection subsystems, Software-Defined Networking (SDN) subsystems, trust subsystems, data management subsystems, compression subsystems, encryption subsystems, and/or any other hardware/software described herein that may be allocated to an LCS that is composed using the resource devices/systems controlled by that SCP device. However, while an SCP device is illustrated and described as performing the functionality discussed below, one of skill in the art in possession of the present disclosure will appreciate that functionality described herein may be enabled on other devices while remaining within the scope of the present disclosure as well.

Thus, the resource system 400 may include the chassis 402 including the SCP device 406 connected to any combinations of resource devices. To provide a specific embodiment, the resource system 400 may provide a “Bare Metal Server” that one of skill in the art in possession of the present disclosure will recognize may be a physical server system that provides dedicated server hosting to a single tenant, and thus may include the chassis 402 housing a processing system and a memory system, the SCP device 406, as well as any other resource devices that would be apparent to one of skill in the art in possession of the present disclosure. However, in other specific embodiments, the resource system 400 may include the chassis 402 housing the SCP device 406 coupled to particular resource devices 404a-404c. For example, the chassis 402 of the resource system 400 may house a plurality of processing systems (i.e., the resource devices 404a-404c) coupled to the SCP device 406. In another example, the chassis 402 of the resource system 400 may house a plurality of memory systems (i.e., the resource devices 404a-404c) coupled to the SCP device 406. In another example, the chassis 402 of the resource system 400 may house a plurality of storage devices (i.e., the resource devices 404a-404c) coupled to the SCP device 406. In another example, the chassis 402 of the resource system 400 may house a plurality of networking devices (i.e., the resource devices 404a-404c) coupled to the SCP device 406. However, one of skill in the art in possession of the present disclosure will appreciate that the chassis 402 of the resource system 400 housing a combination of any of the resource devices discussed above will fall within the scope of the present disclosure as well.

As discussed in further detail below, the SCP device 406 in the resource system 400 will operate with the resource management system 304 (e.g., an SCPM subsystem) to allocate any of its resources devices 404a-404c for use in a providing an LCS. Furthermore, the SCP device 406 in the resource system 400 may also operate to allocate SCP hardware and/or perform functionality, which may not be available in a resource device that it has allocated for use in providing an LCS, in order to provide any of a variety of functionality for the LCS. For example, the SCP engine and/or other hardware/software in the SCP device 406 may be configured to perform encryption functionality, compression functionality, and/or other storage functionality known in the art, and thus if that SCP device 406 allocates storage device(s) (which may be included in the resource devices it controls) for use in a providing an LCS, that SCP device 406 may also utilize its own SCP hardware and/or software to perform that encryption functionality, compression functionality, and/or other storage functionality as needed for the LCS as well. However, while particular SCP-enabled storage functionality is described herein, one of skill in the art in possession of the present disclosure will appreciate how the SCP devices 406 described herein may allocate SCP hardware and/or perform other enhanced functionality for an LCS provided via allocation of its resource devices 404a-404c while remaining within the scope of the present disclosure as well.

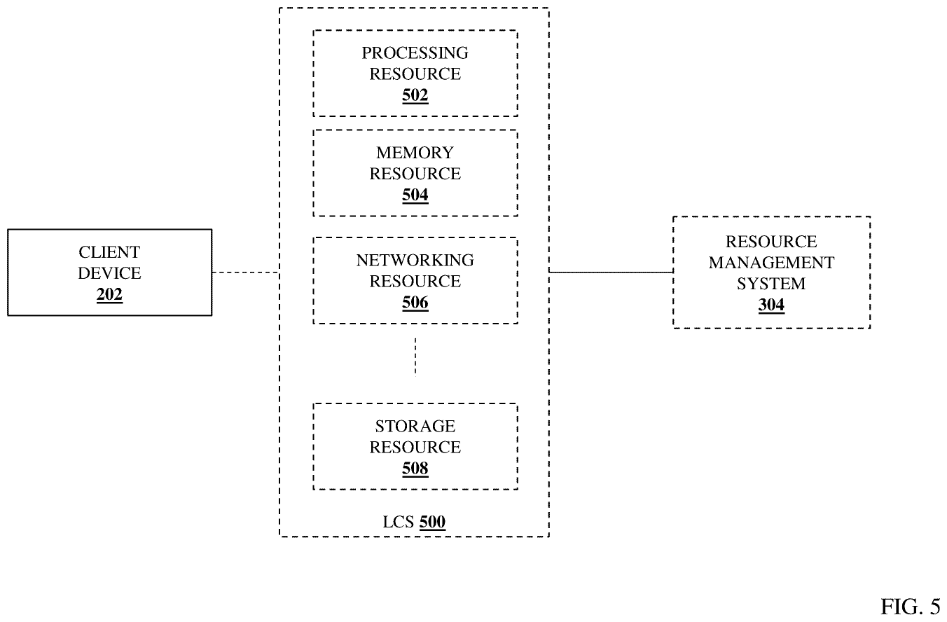

With reference to FIG. 5, an example of the provisioning of an LCS 500 to one of the client device(s) 202 is illustrated. For example, the LCS provisioning system 200 may allow a user of the client device 202 to express a “workload intent” that describes the general requirements of a workload that user would like to perform (e.g., “I need an LCS with 10 gigahertz (Ghz) of processing power and 8 gigabytes (GB) of memory capacity for an application requiring 20 terabytes (TB) of high-performance protected-object-storage for use with a hospital-compliant network”, or “I need an LCS for a machine-learning environment requiring Tensorflow processing with 3 TBs of Accelerator PMEM memory capacity”). As will be appreciated by one of skill in the art in possession of the present disclosure, the workload intent discussed above may be provided to one of the LCS provisioning subsystems 206a-206c, and may be satisfied using resource systems that are included within that LCS provisioning subsystem, or satisfied using resource systems that are included across the different LCS provisioning subsystems 206a-206c.

As such, the resource management system 304 in the LCS provisioning subsystem that received the workload intent may operate to compose the LCS 500 using resource devices 404a-404c in the resource systems 306a-306c/400 in that LCS provisioning subsystem, and/or resource devices 404a-404c in the resource systems 306a-306c/400 in any of the other LCS provisioning subsystems. FIG. 5 illustrates the LCS 500 including a processing resource 502 allocated from one or more processing systems provided by one or more of the resource devices 404a-404c in one or more of the resource systems 306a-306c/400 in one or more of the LCS provisioning subsystems 206a-206c, a memory resource 504 allocated from one or more memory systems provided by one or more of the resource devices 404a-404c in one or more of the resource systems 306a-306c/400 in one or more of the LCS provisioning subsystems 206a-206c, a networking resource 506 allocated from one or more networking devices provided by one or more of the resource devices 404a-404c in one or more of the resource systems 306a-306c/400 in one or more of the LCS provisioning subsystems 206a-206c, and/or a storage resource 508 allocated from one or more storage devices provided by one or more of the resource devices 404a-404c in one or more of the resource systems 306a-306c/400 in one or more of the LCS provisioning subsystems 206a-206c.

Furthermore, as will be appreciated by one of skill in the art in possession of the present disclosure, any of the processing resource 502, memory resource 504, networking resource 506, and the storage resource 508 may be provided from a portion of a processing system (e.g., a core in a processor, a time-slice of processing cycles of a processor, etc.), a portion of a memory system (e.g., a subset of memory capacity in a memory device), a portion of a storage device (e.g., a subset of storage capacity in a storage device), and/or a portion of a networking device (e.g., a portion of the bandwidth of a networking device). Further still, as discussed above, the SCP device(s) 406 in the resource systems 306a-306c/400 that allocate any of the resource devices 404a-404c that provide the processing resource 502, memory resource 504, networking resource 506, and the storage resource 508 in the LCS 500 may also allocate their SCP hardware and/or perform enhanced functionality (e.g., the enhanced storage functionality in the specific examples provided above) for any of those resources that may otherwise not be available in the processing system, memory system, storage device, or networking device allocated to provide those resources in the LCS 500.

With the LCS 500 composed using the processing resources 502, the memory resources 504, the networking resources 506, and the storage resources 508, the resource management system 304 may provide the client device 202 resource communication information such as, for example, Internet Protocol (IP) addresses of each of the systems/devices that provide the resources that make up the LCS 500, in order to allow the client device 202 to communicate with those systems/devices in order to utilize the resources that make up the LCS 500. As will be appreciated by one of skill in the art in possession of the present disclosure, the resource communication information may include any information that allows the client device 202 to present the LCS 500 to a user in a manner that makes the LCS 500 appear the same as an integrated physical system having the same resources as the LCS 500.

Thus, continuing with the specific example above in which the user provided the workload intent defining an LCS with a 10 Ghz of processing power and 8 GB of memory capacity for an application with 20 TB of high-performance protected object storage for use with a hospital-compliant network, the processing resources 502 in the LCS 500 may be configured to utilize 10 Ghz of processing power from processing systems provided by resource device(s) in the resource system(s), the memory resources 504 in the LCS 500 may be configured to utilize 8 GB of memory capacity from memory systems provided by resource device(s) in the resource system(s), the storage resources 508 in the LCS 500 may be configured to utilize 20 TB of storage capacity from high-performance protected-object-storage storage device(s) provided by resource device(s) in the resource system(s), and the networking resources 506 in the LCS 500 may be configured to utilize hospital-compliant networking device(s) provided by resource device(s) in the resource system(s).

Similarly, continuing with the specific example above in which the user provided the workload intent defining an LCS for a machine-learning environment for Tensorflow processing with 3 TBs of Accelerator PMEM memory capacity, the processing resources 502 in the LCS 500 may be configured to utilize TPU processing systems provided by resource device(s) in the resource system(s), and the memory resources 504 in the LCS 500 may be configured to utilize 3 TB of accelerator PMEM memory capacity from processing systems/memory systems provided by resource device(s) in the resource system(s), while any networking/storage functionality may be provided for the networking resources 506 and storage resources 508, if needed.

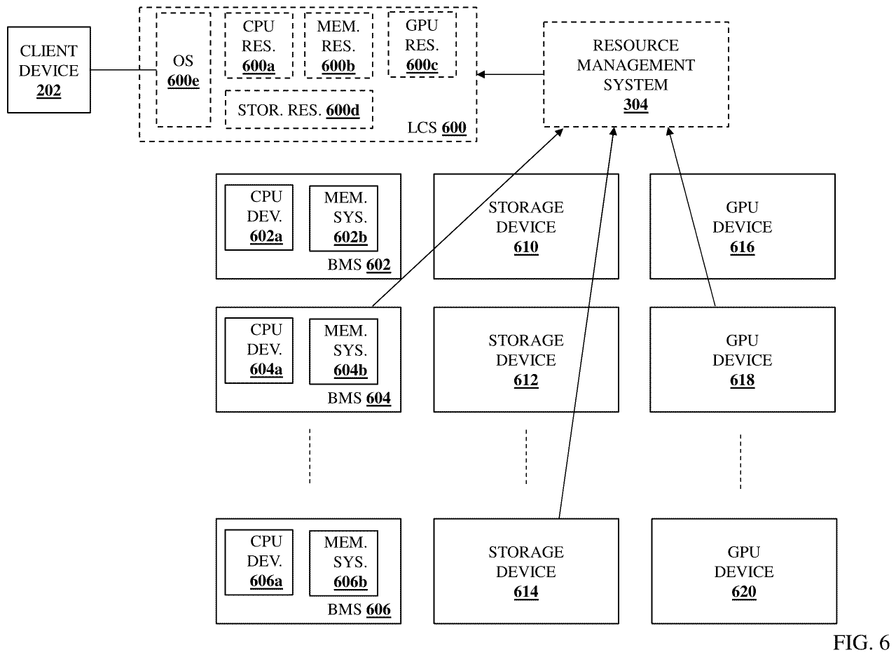

With reference to FIG. 6, another example of the provisioning of an LCS 600 to one of the client device(s) 202 is illustrated. As will be appreciated by one of skill in the art in possession of the present disclosure, many of the LCSs provided by the LCS provisioning system 200 will utilize a “compute” resource (e.g., provided by a processing resource such as an x86 processor, an AMD processor, an ARM processor, and/or other processing systems known in the art, along with a memory system that includes instructions that, when executed by the processing system, cause the processing system to perform any of a variety of compute operations known in the art), and in many situations those compute resources may be allocated from a Bare Metal Server (BMS) and presented to a client device 202 user along with storage resources, networking resources, other processing resources (e.g., GPU resources), and/or any other resources that would be apparent to one of skill in the art in possession of the present disclosure.

As such, in the illustrated embodiment, the resource systems 306a-306c available to the resource management system 304 include a Bare Metal Server (BMS) 602 having a Central Processing Unit (CPU) device 602a and a memory system 602b, a BMS 604 having a CPU device 604a and a memory system 604b, and up to a BMS 606 having a CPU device 606a and a memory system 606b. Furthermore, one or more of the resource systems 306a-306c includes resource devices 404a-404c provided by a storage device 610, a storage device 612, and up to a storage device 614. Further still, one or more of the resource systems 306a-306c includes resource devices 404a-404c provided by a Graphics Processing Unit (GPU) device 616, a GPU device 618, and up to a GPU device 620.

FIG. 6 illustrates how the resource management system 304 may compose the LCS 600 using the BMS 604 to provide the LCS 600 with CPU resources 600a that utilize the CPU device 604a in the BMS 604, and memory resources 600b that utilize the memory system 604b in the BMS 604. Furthermore, the resource management system 304 may compose the LCS 600 using the storage device 614 to provide the LCS 600 with storage resources 600d, and using the GPU device 318 to provide the LCS 600 with GPU resources 600c. As illustrated in the specific example in FIG. 6, the CPU device 604a and the memory system 604b in the BMS 604 may be configured to provide an operating system 600e that is presented to the client device 202 as being provided by the CPU resources 600a and the memory resources 600b in the LCS 600, with operating system 600e utilizing the GPU device 618 to provide the GPU resources 600c in the LCS 600, and utilizing the storage device 614 to provide the storage resources 600d in the LCS 600. The user of the client device 202 may then provide any application(s) on the operating system 600e provided by the CPU resources 600a/CPU device 604a and the memory resources 600b/memory system 604b in the LCS 600/BMS 604, with the application(s) operating using the CPU resources 600a/CPU device 604a, the memory resources 600b/memory system 604b, the GPU resources 600c/GPU device 618, and the storage resources 600d/storage device 614.

Furthermore, as discussed above, the SCP device(s) 406 in the resource systems 306a-306c/400 that allocates any of the CPU device 604a and memory system 604b in the BMS 604 that provide the CPU resource 600a and memory resource 600b, the GPU device 618 that provides the GPU resource 600c, and the storage device 614 that provides storage resource 600d, may also allocate SCP hardware and/or perform enhanced functionality (e.g., the enhanced storage functionality in the specific examples provided above) for any of those resources that may otherwise not be available in the CPU device 604a, memory system 604b, storage device 614, or GPU device 618 allocated to provide those resources in the LCS 500.

However, while simplified examples are described above, one of skill in the art in possession of the present disclosure will appreciate how multiple devices/systems (e.g., multiple CPUs, memory systems, storage devices, and/or GPU devices) may be utilized to provide an LCS. Furthermore, any of the resources utilized to provide an LCS (e.g., the CPU resources, memory resources, storage resources, and/or GPU resources discussed above) need not be restricted to the same device/system, and instead may be provided by different devices/systems over time (e.g., the GPU resources 600c may be provided by the GPU device 618 during a first time period, by the GPU device 616 during a second time period, and so on) while remaining within the scope of the present disclosure as well. Further still, while the discussions above imply the allocation of physical hardware to provide LCSs, one of skill in the art in possession of the present disclosure will recognize that the LCSs described herein may be composed similarly as discussed herein from virtual resources. For example, the resource management system 304 may be configured to allocate a portion of a logical volume provided in a Redundant Array of Independent Disk (RAID) system to an LCS, allocate a portion/time-slice of GPU processing performed by a GPU device to an LCS, and/or perform any other virtual resource allocation that would be apparent to one of skill in the art in possession of the present disclosure in order to compose an LCS.

Similarly as discussed above, with the LCS 600 composed using the CPU resources 600a, the memory resources 600b, the GPU resources 600c, and the storage resources 600d, the resource management system 304 may provide the client device 202 resource communication information such as, for example, Internet Protocol (IP) addresses of each of the systems/devices that provide the resources that make up the LCS 600, in order to allow the client device 202 to communicate with those systems/devices in order to utilize the resources that make up the LCS 600. As will be appreciated by one of skill in the art in possession of the present disclosure, the resource communication information allows the client device 202 to present the LCS 600 to a user in a manner that makes the LCS 600 appear the same as an integrated physical system having the same resources as the LCS 600.

As will be appreciated by one of skill in the art in possession of the present disclosure, the LCS provisioning system 200 discussed above solves issues present in conventional Information Technology (IT) infrastructure systems that utilize “purpose-built” devices (server devices, storage devices, etc.) in the performance of workloads and that often result in resources in those devices being underutilized. This is accomplished, at least in part, by having the resource management system(s) 304 “build” LCSs that satisfy the needs of workloads when they are deployed. As such, a user of a workload need simply define the needs of that workload via a “manifest” expressing the workload intent of the workload, and resource management system 304 may then compose an LCS by allocating resources that define that LCS and that satisfy the requirements expressed in its workload intent, and present that LCS to the user such that the user interacts with those resources in same manner as they would physical system at their location having those same resources.

As discussed above, the resource management system 304 discussed above has conventionally operated as a centralized, monolithic orchestrator device that has been used to configure the resource devices in order to provide the LCSs as described above. However, configuration of LCSs by the resource management system 304 in such a manner requires the resource management system 304 to be provided with a centralized, monolithic Application Programming Interface (API) to configure and manage the resource devices as described above, each of which must be provided with a corresponding API to interact with the resource management system 304. As described above, because hardware and/or software utilized by resource devices scales faster than management and control systems like those provided by the resource management system 304, the APIs provided for resource devices may be updated frequently, with each of those updates requiring a corresponding update in the centralized, monolithic API for the resource management system 304 in order to ensure that the configuration of LCSs discussed above may be performed. Furthermore, in such conventional systems the resource management system 304 must also be provided with all business logic for LCS configuration to handle each of the LCS provisioning variants that are available, and the APIs provided for resource devices must be configured such that they are compliant with API policy standards and API security standards when interacting with the resource management system 304 (i.e., to ensure that they operate within their resource domain and do not compromise the security of the resource domains of other resource devices).

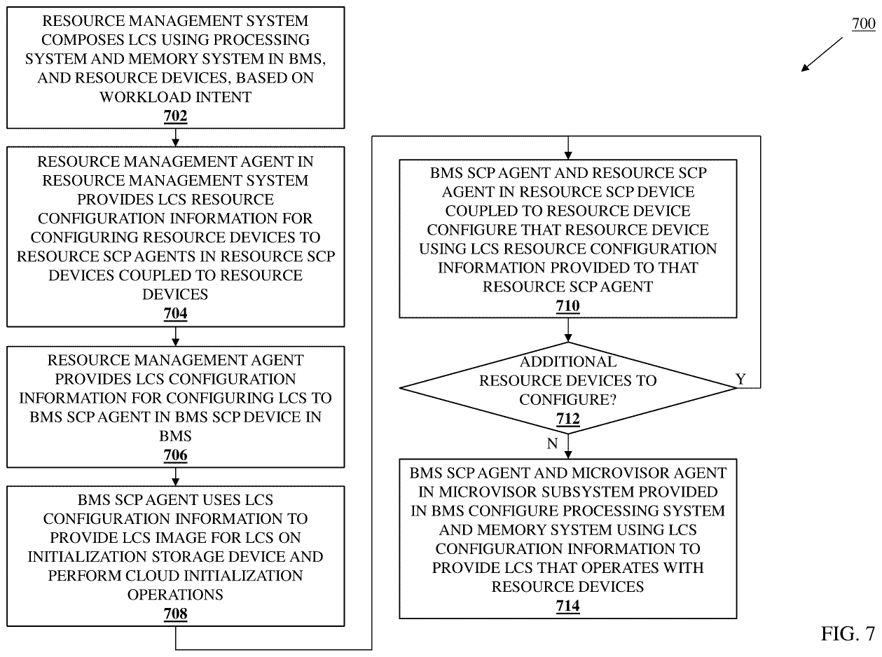

Referring now to FIG. 7, an embodiment of a method 700 for distributed configuration of a Logically Composed System (LCS)is illustrated. As discussed below, the systems and methods of the present disclosure distribute the configuration of an LCS to agents provided for the resource devices used to provide that LCS. For example, the distributed LCS configuration system of the present disclosure may include a BMS with a processing/memory system providing a microvisor including a microvisor agent, and a BMS SCP device including a BMS SCP agent. A resource SCP device is coupled to a resource device and includes a resource SCP agent. A resource management system coupled to the BMS and the resource SCP device includes a resource management agent. The resource management system composes an LCS based on a workload intent using the processing/memory system and the resource device, provides LCS resource configuration information to the resource SCP agent, and provides LCS configuration information to the BMS SCP agent. The BMS SCP agent then configures the first resource device with the first resource SCP agent using the LCS first resource configuration information, and configures the processing/memory system with a microvisor agent using the LCS configuration information to provide the LCS that operates with the resource device. As such, the issues associated with the use of a centralized, monolithic orchestrator device to configure LCSs discussed above are remedied.

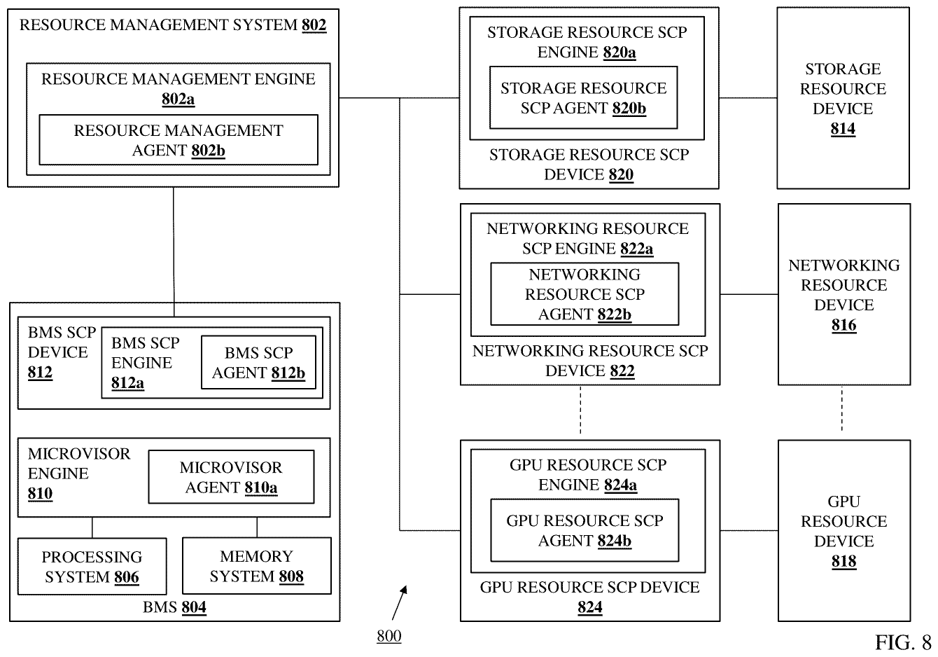

The method 700 begins at block 702 where a resource management system composes an LCS using a processing system and a memory system in an LCS, and resource devices, based on a workload intent. With reference to FIG. 8, an LCS provisioning subsystem 800 illustrated and that may be provided by the LCS provisioning subsystem 300 discussed above with reference to FIG. 3 including the resource systems 306a-306c/400 discussed above with reference to FIGS. 3 and 4. As illustrated, the LCS provisioning subsystem 800 includes a resource management system 800 that may be provided by the resource management system 304 discussed above with reference to FIG. 3. The resource management system 802 may include a resource management processing system (not illustrated, but which may be similar to the processor 102 discussed above with reference to FIG. 1) and a resource management memory system (not illustrated, but which may be similar to the memory 114 discussed above with reference to FIG. 1) that includes instruction that, when executed by the resource management processing system, cause the resource management processing system to provide a resource management engine 802a that is configured to perform the functionality of the resource management engines, resource management subsystems, and/or resource management systems described below.

In the examples provided below, the resource management engine 802a is provided with a resource management agent 802a that is configured to communicate with other agents provided in the LCS provisioning subsystem 800 as described below. As will be appreciated by one of skill in the art in possession of the present disclosure, the resource management agent 802a may be provided with a resource management Application Programming Interface (API) that is configured to receive a workload intent and identify the LCS composed to satisfy that workload intent to microvisor engine 810 in the BMS 804; enable communications between the BMS SCP device 812 and the storage resource SCP device 820, the networking resource SCP device 822, and the GPU resource SCP device 824; record any modifications performed during those communications, and/or perform other resource management API functionality that one of skill in the art in possession of the present disclosure would recognize as providing any of the resource management functionality described below.

In the illustrated embodiment, the LCS provisioning subsystem 800 includes a Bare Metal Server (BMS) 804 that may be provided by any of the BMSs 602-606 discussed above with reference to FIG. 6. The BMS 804 includes a processing system 806 (e.g., which may be provided by the processor 102 discussed above with reference to FIG. 1 such as, for example, a Central Processing Unit (CPU)) and memory system 808 (e.g., which may be provided by the memory 114 discussed above with reference to FIG. 1 such as, for example, Dynamic Random Access Memory (DRAM)), and while the other resource devices in the LCS provisioning subsystem 800 are illustrated as being provided outside of the BMS 804, one of skill in the art in possession of the present disclosure will appreciate how the BMS 804 may include any of those resource devices (or similar resource devices) while remaining within the scope of the present disclosure as well.

As illustrated, the memory system 808 may be provided with instructions that, when executed by the processing system 806, cause the processing system 806 to provide a microvisor engine 810 that is configured to perform the functionality of the microvisor engines, microvisor subsystems, microvisors, and/or BMSs described below. In the examples provided below, the microvisor engine 810 is provided with a microvisor agent 810a that is configured to communicate with the other agent(s) provided in the LCS provisioning subsystem 800 as described below. As will be appreciated by one of skill in the art in possession of the present disclosure, the microvisor agent 802a may be provided with a microvisor Application Programming Interface (API) that is configured to monitor for an LCS that configured to be deployed using the BMS 804 (e.g., by identifying when the storage resource device 814, the networking resource device 816, and the GPU resource device 818 are reserved and configured for use by the LCS), complete the virtualization provisioning for that LCS (via the libvirt domain provisioning described below), and/or perform other microvisor API functionality that one of skill in the art in possession of the present disclosure would recognize as providing any of the microvisor functionality described below.

As illustrated, the BMS 804 also includes a BMS SCP device 812 that may be provided by the SCP device 406 discussed above with reference to FIG. 4. The BMS SCP device 812 may include a BMS SCP processing system (not illustrated, but which may be similar to the processor 102 discussed above with reference to FIG. 1) and a BMS SCP memory system (not illustrated, but which may be similar to the memory 114 discussed above with reference to FIG. 1) that includes instruction that, when executed by the BMS SCP processing system, cause the BMS SCP processing system to provide a BMS SCP engine 812a that is configured to perform the functionality of the BMS SCP engines, BMS SCP subsystems, and/or BMS SCP devices described below.

In the examples provided below, the BMS SCP engine 812a is provided with a BMS SCP agent 812b that is configured to communicate with other agents provided in the LCS provisioning subsystem 800 as described below. As will be appreciated by one of skill in the art in possession of the present disclosure, the BMS SCP agent 812b may be provided with a BMS SCP Application Programming Interface (API) that is configured to monitor the resource management system 802 for LCS configuration instructions for an LCS composed based on a workload intent, communicate with the storage resource SCP device 820, networking resource SCP device 822, and GPU resource SCP device 824 to request resources of the storage resource device 814, the networking resource device 816, and/or GPU resource device 818 that are needed by that LCS, and/or perform other BMS SCP API functionality that one of skill in the art in possession of the present disclosure would recognize as providing any of the BMS SCP functionality described below.

The LCS provisioning subsystem 800 also includes a plurality of resource devices that are illustrated in FIG. 8 as being provided by a storage resource device 814 (e.g., a Solid State Drive (SSD) storage device), a networking resource device 816 (e.g., a Network Interface Controller (NIC) device), and up to a Graphics Processing Unit (GPU) device 818. However, while particular resource devices are illustrated and described, one of skill in the art in possession of the present disclosure will appreciate how any types and/or numbers of resource devices may be provided in the LCS provisioning subsystem 800 and used to provide the LCS as described below.

As illustrated, a storage resource SCP device 820 may couple the storage resource device 814 to the resource management system 802, and may be provided by the SCP device 406 discussed above with reference to FIG. 4. The storage resource SCP device 820 may include a storage resource SCP processing system (not illustrated, but which may be similar to the processor 102 discussed above with reference to FIG. 1) and a storage resource SCP memory system (not illustrated, but which may be similar to the memory 114 discussed above with reference to FIG. 1) that includes instruction that, when executed by the storage resource SCP processing system, cause the storage resource SCP processing system to provide a storage resource SCP engine 820a that is configured to perform the functionality of the storage resource SCP engines, storage resource SCP subsystems, and/or storage resource SCP devices described below.

In the examples provided below, the storage resource SCP engine 820a is provided with a storage resource SCP agent 820b that is configured to communicate with other agents provided in the LCS provisioning subsystem 800 as described below. As will be appreciated by one of skill in the art in possession of the present disclosure, the storage resource SCP agent 820b may be provided with a storage resource SCP Application Programming Interface (API) that is configured to satisfy requests to allocate and provide resources of the storage resource device 814, and/or perform other storage resource SCP API functionality that one of skill in the art in possession of the present disclosure would recognize as providing any of the storage resource SCP functionality described below.

Similarly, a networking resource SCP device 822 may couple the networking resource device 816 to the resource management system 802, and may be provided by the SCP device 406 discussed above with reference to FIG. 4. The networking resource SCP device 822 may include a networking resource SCP processing system (not illustrated, but which may be similar to the processor 102 discussed above with reference to FIG. 1) and a networking resource SCP memory system (not illustrated, but which may be similar to the memory 114 discussed above with reference to FIG. 1) that includes instruction that, when executed by the networking resource SCP processing system, cause the networking resource SCP processing system to provide a networking resource SCP engine 822a that is configured to perform the functionality of the networking resource SCP engines, networking resource SCP subsystems, and/or networking resource SCP devices described below.

In the examples provided below, the networking resource SCP engine 822a is provided with a networking resource SCP agent 822b that is configured to communicate with other agents provided in the LCS provisioning subsystem 800 as described below. As will be appreciated by one of skill in the art in possession of the present disclosure, the networking resource SCP agent 822b may be provided with a networking resource SCP Application Programming Interface (API) that is configured to satisfy requests to allocate and provide resources of the networking resource device 816, and/or perform other networking resource SCP API functionality that one of skill in the art in possession of the present disclosure would recognize as providing any of the networking resource SCP functionality described below.

Similarly, a GPU resource SCP device 824 may couple the GPU resource device 818 to the resource management system 802, and may be provided by the SCP device 406 discussed above with reference to FIG. 4. The GPU resource SCP device 824 may include a GPU resource SCP processing system (not illustrated, but which may be similar to the processor 102 discussed above with reference to FIG. 1) and a GPU resource SCP memory system (not illustrated, but which may be similar to the memory 114 discussed above with reference to FIG. 1) that includes instruction that, when executed by the GPU resource SCP processing system, cause the GPU resource SCP processing system to provide a GPU resource SCP engine 824a that is configured to perform the functionality of the GPU resource SCP engines, GPU resource SCP subsystems, and/or GPU resource SCP devices described below.

In the examples provided below, the GPU resource SCP engine 824a is provided with a GPU resource SCP agent 824b that is configured to communicate with other agents provided in the LCS provisioning subsystem 800 as described below. As will be appreciated by one of skill in the art in possession of the present disclosure, the GPU resource SCP agent 824b may be provided with a GPU resource SCP Application Programming Interface (API) that is configured to satisfy requests to allocate and provide resources of the GPU resource device 818, and/or perform other GPU resource SCP API functionality that one of skill in the art in possession of the present disclosure would recognize as providing any of the GPU resource SCP functionality described below. However, while a specific LCS provisioning system 800 has been illustrated and described in which each resource device is coupled to a respective resource SCP device, one of skill in the art in possession of the present disclosure will appreciate how a resource SCP device may be coupled to a plurality of resource devices and may be configured to perform the resource SCP functionality for each of those resource devices as described below while remaining within the scope of the present disclosure.

Similarly as discussed above, in an embodiment of block 702, the resource management engine 802a in the resource management system 802 may receive a workload intent from a user and, in response, may compose an LCS by identifying the processing system 806 and the memory system 808 in the BMS 804, and each of the storage resource device 814, the networking resource device 816, and the GPU resource device 818, as being capable of satisfying that workload intent. However, while the composition of an LCS using particular resource devices is illustrated and described below, one of skill in the art in possession of the present disclosure will appreciate how LCSs may be composed using different numbers and/or types of resource devices that depend on the details of the corresponding workload intent received from a user.

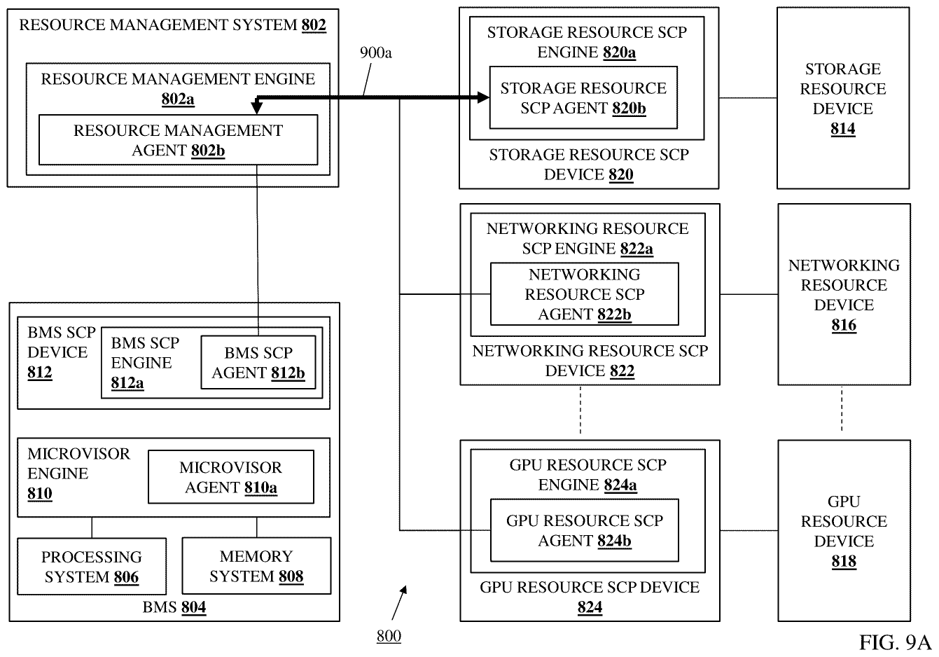

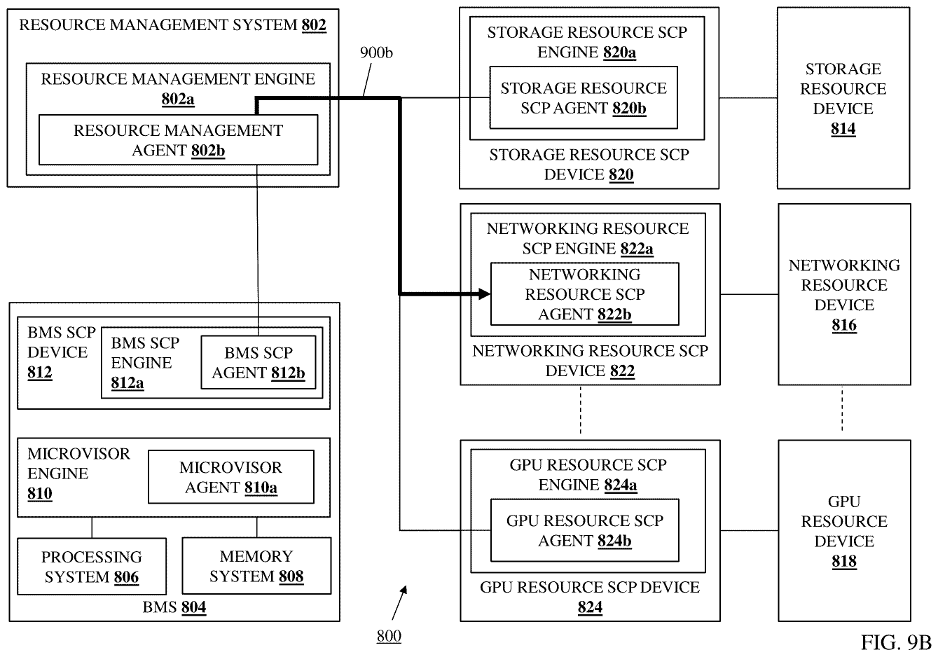

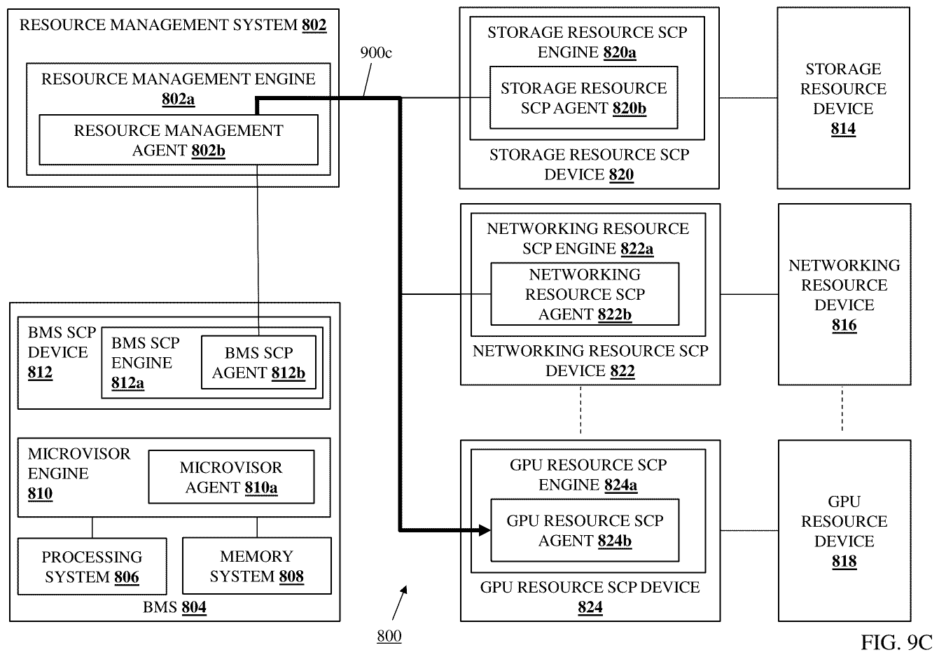

The method 700 then proceeds to block 704 where a resource management agent in the resource management system provides LCS resource configuration information for configuring resource devices to resource SCP agents in resource SCP devices coupled to resource devices. With reference to FIG. 9A, in an embodiment of block 704, the resource management agent 802b provided by the resource management engine 802a in the resource management system 802 may perform storage resource configuration information provisioning operations 900a that include generating storage resource configuration information for the storage resource device 814 that provides for the configuration of the storage resource device 814 to operate with the LCS composed at block 712, and transmitting that storage resource configuration information to the storage resource SCP agent 820b provided by the storage resource SCP engine 820a in the storage resource SCP device 820.

In an embodiment, the storage resource configuration information provisioning operations 900a may include the resource management agent 802b and the storage resource SCP agent 820b communicating via their resource management API and storage resource SCP API, respectively, to provide storage resource type, capability, and state information about the storage resource device 814 to the resource management agent 802b (e.g., the storage resource SCP API may include keys, tags, labels that store the storage resource type, capability, and state information for retrieval by the resource management API) for use in generating the storage resource configuration information. As described below, the storage resource configuration information generated and provided to the storage resource SCP agent 820b at block 704 may include storage device attachment operation instructions, storage location identifiers (e.g. a block path, a volume index, physical function identifiers, virtual function identifiers, etc.), storage capacity requests, an operating system image and cloud initialization keys for a corresponding operating system (if the storage resource device 814 is being used to host an operating system for an LCS), and/or other storage resource configuration information that one of skill in the art in possession of the present disclosure would recognize as providing the functionality described below.

With reference to FIG. 9B, in an embodiment of block 704, the resource management agent 802b provided by the resource management engine 802a in the resource management system 802 may perform networking resource configuration information provisioning operations 900b that include generating networking resource configuration information for the networking resource device 816 that provides for the configuration of the networking resource device 816 to operate with the LCS composed at block 712, and transmitting that networking resource configuration information to the networking resource SCP agent 822b provided by the networking resource SCP engine 822a in the networking resource SCP device 822.

In an embodiment, the networking resource configuration information provisioning operations 900b may include the resource management agent 802b and the networking resource SCP agent 822b communicating via their resource management API and networking resource SCP API, respectively, to provide networking resource type, capability, and state information about the networking resource device 816 to the resource management agent 802b (e.g., the networking resource SCP API may include keys, tags, labels that store the networking resource type, capability, and state information for retrieval by the resource management API) for use in generating the networking resource configuration information. As described below, the networking resource configuration information generated and provided to the networking resource SCP agent 822b at block 704 may include networking bandwidth reservation operation instructions, a network interface locator (e.g., a PCIe address), a subnet, Internet Protocol (IP) addresses, a Domain Name Server (DNS) addresses, a Media Access Control (MAC) address,, and/or other networking resource configuration information that one of skill in the art in possession of the present disclosure would recognize as providing the functionality described below.

With reference to FIG. 9C, in an embodiment of block 704, the resource management agent 802b provided by the resource management engine 802a in the resource management system 802 may perform GPU resource configuration information provisioning operations 900c that include generating GPU resource configuration information for the GPU resource device 816 that provides for the configuration of the networking resource device 818 to operate with the LCS composed at block 712, and transmitting that GPU resource configuration information to the GPU resource SCP agent 824b provided by the GPU resource SCP engine 824a in the GPU resource SCP device 824.

In an embodiment, the GPU resource configuration information provisioning operations 900c may include the resource management agent 802b and the GPU resource SCP agent 824b communicating via their resource management API and GPU resource SCP API, respectively, to provide GPU resource type, capability, and state information about the GPU resource device 818 to the resource management agent 802b (e.g., the GPU resource SCP API may include keys, tags, labels that store the GPU resource type, capability, and state information for retrieval by the resource management API) for use in generating the GPU resource configuration information. As described below, the GPU resource configuration information generated and provided to the GPU resource SCP agent 824b at block 704 may include a required GPU bandwidth or capacity, Peripheral Component Interconnect (PCI) addresses, and/or other GPU resource configuration information that one of skill in the art in possession of the present disclosure would recognize as providing the functionality described below.

However, while specific LCS resource configuration information for particular resource devices has been described, one of skill in the art in possession of the present disclosure will appreciate how LCS resource configuration information for particular resource devices will differ based on the characteristics of those resource devices, and the generation and provisioning of any LCS resource configuration information to the resource SCP devices coupled to those resource devices will fall within the scope of the present disclosure.

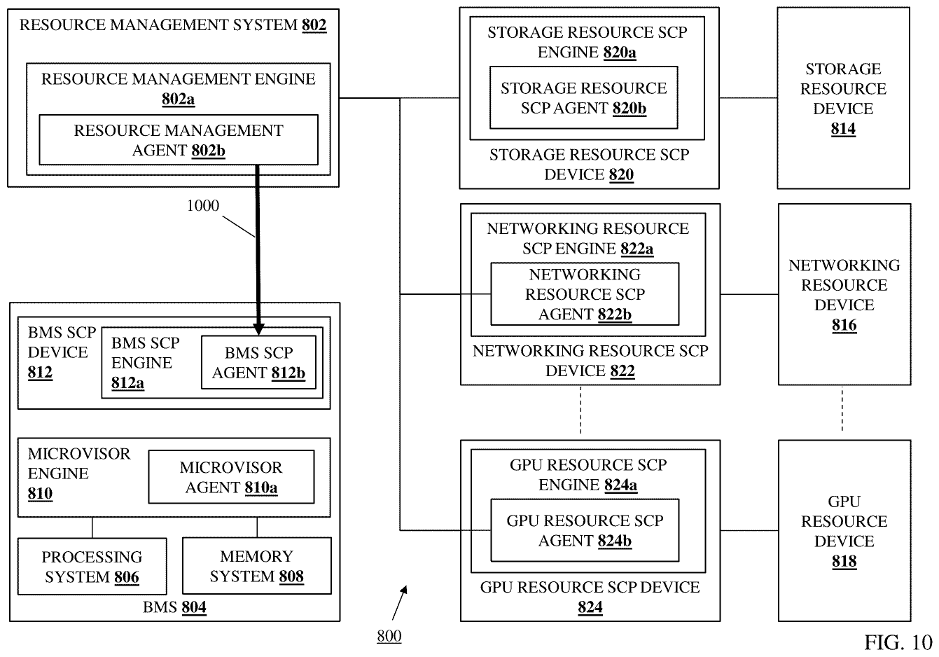

The method 700 then proceeds to block 706 where the resource management agent provides LCS configuration information for configuring the LCS to a BMS SCP agent in a BMS SCP device included in the BMS. With reference to FIG. 10, in an embodiment of block 706, the resource management agent 802b provided by the resource management engine 802a in the resource management system 802 may perform LCS configuration information provisioning operations 1000 that include generating LCS configuration information that provides for the configuration of the LCS composed at block 712 on the processing system 806 and memory system 808 in the BMS 804, and transmitting that LCS configuration information to the BMS SCP agent 812b provided by the BMS SCP engine 812a in the BMS SCP device 812.

In an embodiment, the LCS configuration information provisioning operations 1000 may include the resource management agent 802b and the BMS SCP agent 812b communicating via their resource management API and BMS SCP API, respectively, to provide microvisor type, capability, and state information about the microvisor engine 810 to the resource management agent 802b (e.g., the microvisor API may include keys, tags, labels that store the microvisor type, capability, and state information for retrieval by the resource management API) for use in generating the LCS configuration information. As described below, the LCS configuration information generated and provided to the BMS SCP agent 812b at block 706 may include an LCS image for the LCS, cloud initialization operation instructions, storage resource device attachment information, networking resource device attachment information, GPU resource device attachment information,, and/or other LCS configuration information that one of skill in the art in possession of the present disclosure would recognize as providing the functionality described below.

However, while specific LCS configuration information for an LCS that utilizes particular resource devices has been described, one of skill in the art in possession of the present disclosure will appreciate how LCS configuration information for an LCS will differ based on the characteristics of that LCS, and the generation and provisioning of any LCS configuration information to the BMS SCP device will fall within the scope of the present disclosure.

The method 700 then proceeds to block 708 where the BMS SCP agent uses the LCS configuration information to provide an LCS image for the LCS on an initialization storage device and perform cloud initialization operations. In an embodiment, at block 708, the BMS SCP agent 812b provided by the BMS SCP engine 812a in the BMS SCP device 812 may provide the LCS image received in the LCS configuration information at block 706 on an initialization storage device (e.g., the memory system 808 or other storage in the BMS 804), and may utilize the cloud initialization operation instructions received in the LCS configuration information at block 706 to perform cloud initialization operations that may include storage override operations, networking override operations, system configuration override operations, user accounts creation operations, additional/custom software module/service provisioning operations, startup automation process configuration operations, and/or any other cloud initialization operations that would be apparent to one of skill in the art in possession of the present disclosure.

The method 700 then proceeds to block 710 where the BMS SCP agent and a resource SCP agent in a resource SCP device coupled to a resource device configure that resource device using the LCS resource configuration information provided to that resource SCP agent. As described below, the BMS SCP agent 812b provided by the BMS SCP engine 812a in the BMS SCP device 812 may operate at block 710 with the resource SCP agent in the resource SCP device coupled to each resource device that was used to compose the LCS to configure those resource devices using the LCS resource configuration information that was provided to their corresponding resource SCP agents at block 704.

For example, in an embodiment of a first performance of block 710, the BMS SCP agent 812b, the resource management agent 802b, and the storage resource SCP agent 820b may utilize the BMS SCP API, the resource management API, and storage resource SCP API, respectively, described above to use the storage resource configuration information provided to the storage resource SCP agent 820b at block 704 to perform storage resource device configuration operations 1100a that include configuring the storage resource device 814 to operate with the LCS composed at block 702 by, for example, executing the storage device attachment operation instructions included in the storage resource configuration information to perform storage device attachment operations for the storage resource device 814 (e.g., if the available capacity on the storage resource device 814 is adequate for the LCS being provided, the storage resource SCP device 820 will allocate a storage block and provide storage location identifiers (e.g. a block path identifier, a volume index identification, a physical function identifier, a virtual function identifier, etc.) to the storage resource SCP agent 820b, and the storage resource SCP agent 820b will use the storage location identifiers to perform the storage device attachment operations for the storage resource device 814), sharing the storage location identifiers with the resource management system 802 for use in the LCS configuration operations discussed below (e.g., the libvirt domain provisioning discussed below), writing an LCS image and cloud initialization information on the storage resource device 814 if the storage resource device 814 is being used as a boot disk., and/or other storage resource configuration operations that one of skill in the art in possession of the present disclosure would recognize as configuring the storage resource device 814 to operate with an LCS. As will be appreciated by one of skill in the art in possession of the present disclosure, the resource management agent 802b may operate as a “passthrough” for communications between the BMS SCP agent 812b and the storage resource SCP agent 820b at block 710.

The method 700 then proceeds to decision block 712 where the method 700 proceeds depending on whether there are additional resource devices to configure. As discussed below, the BMS SCP agent 812b will operate to configure each of the resource devices that were used to compose the LCS at block 702 and thus, if at decision block 712 there are additional resource devices to configure, the method 700 returns to block 710. As such, the method 700 may loop through blocks 710 and 712 to configure each of the resource devices that were used to compose the LCS at block 710.

For example, in an embodiment of a second performance of block 710, the BMS SCP agent 812b, the resource management agent 802b, and the networking resource SCP agent 822b may utilize the BMS SCP API, the resource management API, and networking resource SCP API, respectively, described above to use the networking resource configuration information provided to the networking resource SCP agent 822b at block 704 to perform networking resource device configuration operations 1102a that include configuring the networking resource device 816 to operate with the LCS composed at block 702 by, for example, executing the networking bandwidth reservation operation instructions included in the storage resource configuration information to perform networking bandwidth reservation operations for the networking resource device 816 (e.g., if the networking resource device 816 has adequate network interfaces available for the LCS being provided, the networking resource SCP agent 822b will reserve the next available network interface, identify a PCIe address of that network interface, and provide that PCIe address for that network interface to the resource management system 802 for use in the LCS configuration operations discussed below (e.g., the libvirt domain provisioning discussed below), and/or other networking resource configuration operations that one of skill in the art in possession of the present disclosure would recognize as configuring the networking resource device 814 to operate with an LCS. As will be appreciated by one of skill in the art in possession of the present disclosure, the resource management agent 802b may operate as a “passthrough” for communications between the BMS SCP agent 812b and the networking resource SCP agent 822b at block 710.

In another example, in an embodiment of a third performance of block 710, the BMS SCP agent 812b, the resource management agent 802b, and the GPU resource SCP agent 824b may utilize the BMS SCP API, the resource management API, and GPU resource SCP API, respectively, described above to use the GPU resource configuration information provided to the GPU resource SCP agent 824b at block 704 to perform GPU resource device configuration operations 1104a that include configuring the GPU resource device 818 to operate with the LCS composed at block 702 by, for example, the GPU resource SCP agent 824b reserving GPU resources from the GPU resource device 818 (if available) for the LCS being provided and identifying PCIe addresses of those GPU resources and providing them to the resource management system 802 for use in the LCS configuration operations discussed below (e.g., the libvirt domain provisioning discussed below), and/or other GPU resource configuration operations that one of skill in the art in possession of the present disclosure would recognize as configuring the GPU resource device 814 to operate with an LCS. As will be appreciated by one of skill in the art in possession of the present disclosure, the resource management agent 802b may operate as a “passthrough” for communications between the BMS SCP agent 812b and the GPU resource SCP agent 824b at block 710.

If, at decision block 712, there are no additional resource devices to configure, the method 700 proceeds to block 714 where the BMS SCP agent and a microvisor agent in a microvisor subsystem provided in the BMS configure the processing system and memory system using the LCS configuration information to provide the LCS that operates with the resource devices. In an embodiment, at decision bock 712 the microvisor agent 810a and the BMS SCP agent 812b may monitor the operations of the resource management agent 802b at 710 to determine when the resource devices being configured are “ready” and, in response, may perform the processing system and memory system configuration at block 714. For example, the resource management agent 802b may compile “updated” LCS configuration information that is generated and provided to the resource management system 802 at blocks 702-710 of the method 700 and provide that “updated” LCS configuration information to the microvisor agent 810a and the BMS SCP agent 812b for use in configuring the LCS as described below.

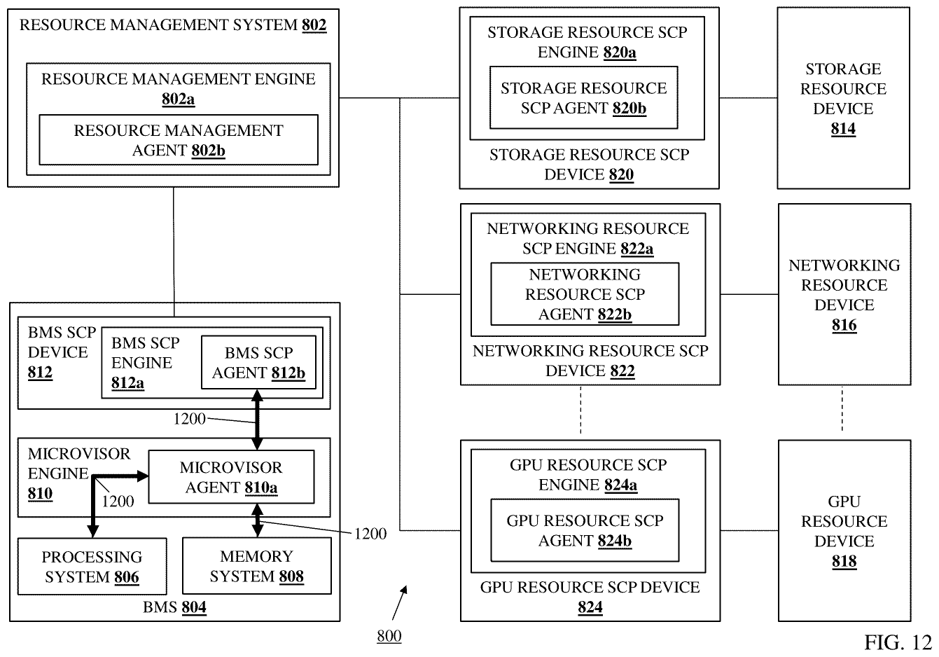

With reference to FIG. 12, in an embodiment of block 714, the BMS SCP agent 812b and the microvisor agent 810a may utilize the BMS SCP API and the microvisor API, respectively, described above to use the LCS configuration information provided to the BMS SCP agent 812b at block 706 and updated as described above to perform LCS configuration operations 1104a that include configuring the processing system 806 and the memory system 808 to provide the LCS composed at block 702 that operates with the storage resource device 814, the networking resource device 816, and the GPU resource device 818 by, for example, providing a libvirt domain for the processing system 806 and the memory system 808 using the microvisor agent 810a that includes the LCS image, cloud initialization information, and resource device configuration information that provides the “core” of the LCS, and/or other LCS configuration operations that one of skill in the art in possession of the present disclosure would recognize as configuring the an LCS to operate with storage resource device 814, the networking resource device 816, and the GPU resource device 818 that were configured at block 710.

As will be appreciated by one of skill in the art in possession of the present disclosure, when the LCS is “ready” at decision block 714, the resource management agent 802b has a record of the workload intent and the resource device configuration information complied at blocks 702-710 of the method 700, with the workload intent including user requested capabilities for the LCS that may be enabled via the microvisor engine 810 using the processing system 806 and memory system 808 and the resource device configuration information including PCIe addresses of the storage resource device 814, the networking resource device 816, and the GPU resource device 818 that the microvisor engine 810 may use to locate the storage resource device 814, the networking resource device 816, and the GPU resource device 818, attach them to the LCS, and utilize them as part of the provisioning of the LCS. As such, one of skill in the art in possession of the present disclosure will appreciate how the systems and methods of the present disclosure move the resource device configuration and handling for an LCS from the resource management system 802 (which as traditionally operated as the centralized, monolithic orchestrator device described above) to the microvisor engine 810, freeing the resource management system 802 from the need to provide microvisor-based logic (e.g., inventory logic, networking logic, libvirt domain logic, etc.).

Thus, systems and methods have been described that distribute the configuration of an LCS to agents provided for the resource devices used to provide that LCS. For example, the distributed LCS configuration system of the present disclosure may include a BMS with a processing/memory system providing a microvisor including a microvisor agent, and a BMS SCP device including a BMS SCP agent. A resource SCP device is coupled to a resource device and includes a resource SCP agent. A resource management system coupled to the BMS and the resource SCP device includes a resource management agent. The resource management system composes an LCS based on a workload intent using the processing/memory system and the resource device, provides LCS resource configuration information to the resource SCP agent, and provides LCS configuration information to the BMS SCP agent. The BMS SCP agent then configures the first resource device with the first resource SCP agent using the LCS first resource configuration information, and configures the processing/memory system with a microvisor agent using the LCS configuration information to provide the LCS that operates with the resource device.

As will be appreciated by one of skill in the art in possession of the present disclosure, the systems and methods of the present disclosure offload and disaggregate business logic handling of LCSs from their orchestration, with agents for the microvisor “pulling” configured resource devices for use with an LCS rather than the resource management system 304 “pushing” configured resource devices to the microvisor, allowing the LCS provisioning to flow through stages based on state changes rather than requiring hardware for the LCS to be “pushed” by the resource management system 304. Thus, the abstraction of managing LCSs is “pushed” to the microvisor (e.g., via the provisioning of the libvirt domain by the microvisor as discussed above) and hardware disaggregation machinery level of the system, which enables secure connectivity that is “locally” scoped to the libvirt domain and microvisor management and connectivity. The systems and methods of the present disclosure provide flexibility in the implementation of microvisor-managed virtualization/hardware presentation that is abstracted from API operations and modeled states, and allows interactions between resource devices provided by disaggregated hardware on a centralized control plane due to the shared API modeling described above (e.g., scheduling and solving drift/state occurs with services in a common modeling/domain layer, moving the complex modeling of LCS resource management to a microvisor that provides the hardware/virtualization/presentation via the libvirt domain discussed above).

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A distributed Logically Composed System (LCS) configuration system, comprising:
a Bare Metal Server (BMS) including:
a processing system and a memory system that are configured to provide a microvisor subsystem including a microvisor agent; and
a BMS System Control Processor (SCP) device that is coupled to the processing and the memory system, and that includes a BMS SCP agent;
a first resource SCP device that is coupled to a first resource device, and that includes a first resource SCP agent;
a resource management system that is coupled to the BMS and the first resource SCP device, that includes a resource management agent, and that is configured to:
receive a workload intent;
compose, based on the workload intent, a Logically Composed System (LCS) using the processing system, the memory system, and the first resource device;
provide, to the first resource SCP agent using the resource management agent, LCS first resource configuration information for configuring the first resource device; and
provide, to the BMS SCP agent using the resource management agent, LCS configuration information for configuring the LCS,
wherein the BMS SCP agent is configured to:
configure, with the first resource SCP agent using the LCS first resource configuration information, the first resource device; and
configure, with the microvisor agent using the LCS configuration information, the processing system and the memory system to provide the LCS that operates with the first resource device.

2. The system of claim 1, further comprising:
a second resource SCP device that is coupled to a second resource device and the resource management system, and that includes a second resource SCP agent, wherein the resource management system is configured to:
compose, based on the workload intent, the LCS using the processing system, the memory system, the first resource device, and the second resource device; and
provide, to the second SCP agent using the resource management agent, LCS second resource configuration information for configuring the second resource device,
wherein the BMS SCP agent is configured to:
configure, with the second resource SCP agent using the LCS second resource configuration information, the second resource device; and
configure, with the microvisor agent using the LCS configuration information, the processing system and the memory system to provide the LCS that operates with the first resource device and the second resource device.

3. The system of claim 1, wherein the first resource device is provided by a storage resource device, and the second resource device is provided by a networking resource device.

4. The system of claim 3, wherein the BMS SCP agent and the first resource SCP agent use the LCS first resource configuration information to perform storage device attachment operations for the storage second device, and wherein the BMS SCP agent and the second resource SCP agent use the LCS second resource configuration information to perform networking bandwidth reservation operations for the networking resource device.

5. The system of claim 1, wherein the BMS SCP agent is configured to use the LCS configuration information to provide an LCS image for the LCS on an initialization storage device.

6. The system of claim 1, wherein the BMS SCP agent is configured to use the LCS configuration information to perform cloud initialization operations.

7. The system of claim 1, wherein the configuring the processing system and the memory system to provide the LCS that operates with the first resource device includes the microvisor agent using the LCS configuration information to provide a libvirt domain for the processing system and the memory system.

8. A Bare Metal Server (BMS), comprising:
a Bare Metal Server (BMS) System Control Processor (SCP) processing system;
a BMS SCP memory system that is coupled to the BMS SCP processing system and that includes instructions that, when executed by the BMS SCP processing system, cause the BMS SCP processing system to provide a BMC SCP engine including a BMC SCP agent;
a microvisor processing system; and
a microvisor memory system that is coupled to the microvisor processing system and that includes instructions that, when executed by the microvisor processing system, cause the microvisor processing system to provide a microvisor engine including a microvisor agent, wherein the BMC SCP agent is configured to:
receive, from a resource management agent in a resource management system, Logically Composed System (LCS) configuration information for configuring an LCS;
configure, with a first resource SCP agent included in a first resource SCP device using LCS first resource configuration information provided on the first resource SCP device, a first resource device that is coupled to the first resource SCP; and
configure, with microvisor agent using LCS configuration information provided on the microvisor engine, the microvisor processing system and the microvisor memory system to provide the LCS that operates with the first resource device.

9. The BMS of claim 8, wherein the BMC SCP agent is configured to:
configure, with a second resource SCP agent included in a second resource SCP device using LCS second resource configuration information provided on the second resource SCP device, a second resource device that is coupled to the second resource SCP device; and
configure, with microvisor agent using LCS configuration information provided on the microvisor engine, the microvisor processing system and the microvisor memory system to provide the LCS that operates with the second resource device.

10. The BMS of claim 8, wherein the first resource device is provided by a storage resource device, and the second resource device is provided by a networking resource device.

11. The BMS of claim 10, wherein the BMS SCP agent and the first resource SCP agent use the LCS first resource configuration information to perform storage device attachment operations for the storage second device, and wherein the BMS SCP agent and the second resource SCP agent use the LCS second resource configuration information to perform networking bandwidth reservation operations for the networking resource device.

12. The BMS of claim 8, wherein the BMS SCP agent is configured to use the LCS configuration information to provide an LCS image for the LCS on an initialization storage device.

13. The BMS of claim 8, wherein the BMS SCP agent is configured to use the LCS configuration information to perform cloud initialization operations.

14. A method for distributed configuration of a Logically Composed System (LCS), comprising:
receiving, by a resource management system, a workload intent;
composing, by the resource management system based on the workload intent, a Logically Composed System (LCS) using a processing system and a memory system in a Bare Metal Server (BMS), and a first resource device;
providing, by a resource management agent in the resource management system to a first SCP agent included in a first resource SCP device that is coupled to the first resource device, LCS first resource configuration information for configuring the first resource device;
providing, by the resource management agent to a BMS SCP agent included in a BMC SCP device in the BMS, LCS configuration information for configuring the LCS;
configuring, by the BMS SCP agent with the first resource SCP agent using the LCS first resource configuration information, the first resource device; and
configuring, by the BMS SCP agent and a microvisor agent included in a microvisor subsystem that is provided using the processing system and the memory system and using the LCS configuration information, the processing system and the memory system to provide the LCS that operates with the first resource device.

15. The method of claim 14, further comprising:
composing, by the resource management system based on the workload intent, the LCS using the processing system, the memory system, the first resource device, and the second resource device;
providing, by the resource management agent to a second SCP agent included in a second resource SCP device that is coupled to the second resource device, LCS second resource configuration information for configuring the second resource device;
configuring, by the BMS SCP agent with the second resource SCP agent using the LCS second resource configuration information, the second resource device; and
configuring, by the BMS SCP agent with the microvisor agent using the LCS configuration information, the processing system and the memory system to provide the LCS that operates with the second resource device.

16. The method of claim 14, wherein the first resource device is provided by a storage resource device, and the second resource device is provided by a networking resource device.

17. The method of claim 16, wherein the BMS SCP agent and the first resource SCP agent use the LCS first resource configuration information to perform storage device attachment operations for the storage second device, and wherein the BMS SCP agent and the second resource SCP agent use the LCS second resource configuration information to perform networking bandwidth reservation operations for the networking resource device.

18. The method of claim 14, further comprising:
providing, by the BMS SCP agent using the LCS configuration information, an LCS image for the LCS on an initialization storage device.

19. The method of claim 14, further comprising:
performing, by the BMS SCP agent using the LCS configuration information, cloud initialization operations.

20. The method of claim 14, wherein the configuring the processing system and the memory system to provide the LCS that operates with the first resource device includes the microvisor agent using the LCS configuration information to provide a libvirt domain for the processing system and the memory system.
